(19) United States
(12) Patent Application Publication
(10) Pub. No.: US 2004/0108226 A1
(43) Pub. Date: Jun. 10, 2004

(54) Continuous glucose quantification device and method

(76) Inventors: Constantin Polychronakos, Montreal (CA); Marcus F. Lawrence, Chambly (CA); Olivier Leloup, Montreal (CA)

Correspondence Address: Jane Massey Licata, Licata & Tyrrell P.C., 66 E. Main Street, Marlton, NJ, 08053, US

(21) Appl. No.: 10/695,014

(22) Filed: Oct. 28, 2003

Related U.S. Application Data
(60) Provisional application No. 60/422,253, filed on Oct. 28, 2002.

(51) Int. Cl. G01N 27/26

(52) U.S. Cl. 205/792; 204/403.11

(57) ABSTRACT

A device and method for glucose quantification in a liquid medium using a reference electrode; a counter electrode and a working electrode with a semipermeable membrane is provided.

This application claims the benefit of U.S. Provisional Application No. 60/422,253 filed Oct. 28, 2002.

### FIELD OF THE INVENTION

This invention relates to a device for quantification of glucose levels in a diabetic patient. In certain embodiments the device provides a feedback mechanism to administer insulin to a patient and modulate the amount of glucose present in the blood of a patient.

### BACKGROUND OF THE INVENTION

Diabetes is a major cause of illness and death, and any technology that improves the health and life of affected patients has an enormous market potential. Diabetes is due to deficiency of insulin, either absolute known as Type 1 diabetes, or partial and relative to increased requirements, known as Type 2 diabetes. Type 1 and often Type 2 diabetes are treated with injections of insulin, a hormone that enables cells to take up sugar in the form of glucose and use it or store it. In the absence of insulin, glucose cannot enter the cells and accumulates in the extracellular space, not only in blood where it is conventionally measured, but equally in the interstitial space between cell in various tissues.

Unless the levels of extracellular glucose are controlled to normal or near normal levels on a daily basis, the patient runs a high risk of crippling and life-threatening long-term complications such as retinopathy, blindness, limb gangrene often resulting in amputation, and kidney damage requiring dialysis or transplantation. Diabetes is the most common cause of acquired blindness and one of the most common causes of terminal kidney failure.

The amount of insulin required to maintain acceptable glucose levels varies from day to day and from hour to hour according to a patients food intake, exercise, emotional state and many other factors. Non-diabetic individuals maintain remarkably stable glucose levels because the pancreas, namely pancreatic beta cells, can sense extracellular glucose levels and release the appropriate amount of insulin on a minute to minute basis. This feedback loop system does not exist in the insulin dependent diabetic whose dose of insulin is a matter of an educated guess and, even in the intensive treatment of four injections a day, cannot be adjusted more than several hours apart. Underestimating the dose results in too high glucose levels, overestimating the cause results in hypoglycemia. Portable pumps for constant subcutaneous insulin infusion (CSII) allow programming of the infusion rate throughout 24 hours, but the programming must be based on finger-prick blood glucose measurements, typically obtained not more than four times a day. Determining rates for the times in between remains an educated guess. In its present form therefore, CSII represents a marginal improvement over insulin injections. Even this small benefit requires frequent testing and adjusting on the part of the patient making it realistic for only a small minority of the most motivated patients.

Functional glucose sensors are available which require the enzyme glucose oxidase. The hydrogen peroxide resulting from oxidation of glucose is detected by an electrode. Relying on an enzymatic reaction this sensor causes the consumption of substrate and accumulation of product. The result is constant drift, and need for frequent calibration and unreliable results. The sensor must be replaced every three days. Not only are these sensors not reliable enough for a feedback loop, their regulatory status even prohibits this electronic mechanism from releasing the results to a patient prior to the end of a three day period, in order to avoid reliance on them in real time. They are used solely as sources of retrospective insight that aid in the educated guessing of insulin doses. Other technologies which rely on irreversible reaction have been studied, but none have advanced to a stage of clinical studies.

U.S. Pat. No. 6,150,106 and U.S. Pat. No. 5,869,244 disclose detection of compounds involved in immunological coupling reactions including macromolecules such as antibodies and antigens. There is no teaching regarding diabetic patients and glucose quantification or regulation.

Concanavalin A (conA), is a protein that reversibly binds glucose with milimolar affinity making it useful for concentrations close to those seen in human body fluids. Reversible binding has the advantage of improved stability over irreversible enzymatic reaction. On the other hand, detecting this binding and converting it to output in terms of glucose levels has not yet been realized.

The present invention senses non-covalent interactions with surface immobilized conA by its effect on electrical impedance of the surface.

### SUMMARY OF THE INVENTION

An object of the present invention is to provide a glucose quantification device for determining the concentration of glucose in a liquid medium comprising a reference electrode, a counter electrode and a working electrode with a semipermeable membrane immersed in a liquid medium in which at least one chemical entity is dissolved; a potentiostat for applying a measurement potential to the working electrode relative to the reference electrode corresponding to a measurement voltage during at least a portion of measurement period, and thereby causing said chemical entity to participate in an electrochemical reaction at the working electrode, said electrochemical reaction resulting in a impedance measurement evoked current, a measuring unit for said impedance measurement evoked current; and a means for comparing said impedance measurement evoked current with a predetermined value to obtain a comparison result.

A further object of the present invention is to provide a glucose quantification device for determining the concentration of glucose in a liquid medium comprising a reference electrode, a counter electrode; a working electrode with a semipermeable membrane and a feedback loop pump which administers an amount of insulin to a patient to modulate the glucose levels.

A yet further object of present invention is to provide a method of modulating glucose in a patient comprising immersing a glucose quantification device for determining the concentration of glucose in a liquid medium comprising a reference electrode, a counter electrode and a working electrode with a semipermeable membrane immersed in a liquid medium in which at least one chemical entity is present; applying a measurement potential to the working electrode relative to the reference electrode to result in a impedance measurement evoked current; measuring said impedance measurement evoked current; comparing said impedance measurement evoked current with a predetermined value to determine whether the chemical entity in the liquid medium is within a normal range; and administering an amount of insulin to the patient to modulate the concentration of the chemical entity in the liquid medium and regulate glucose levels.

### BRIEF DESCRIPTION OF DRAWINGS

FIG. 1 shows a schematic representation of one embodiment of the glucose quantification device.

### DETAILED DESCRIPTION OF THE INVENTION

Continuous direct glucose quantification is a highly desirable goal in improving management of diabetes. Towards the development of a robust non-enzymatic method based on reversible binding to the lectin Concanavalin A (ConA), it has been found that chemical binding is quantitatively detected by its effect on electrochemical impedance of ConA coated substrates, particularly Si or Si/SiO₂ substrates.

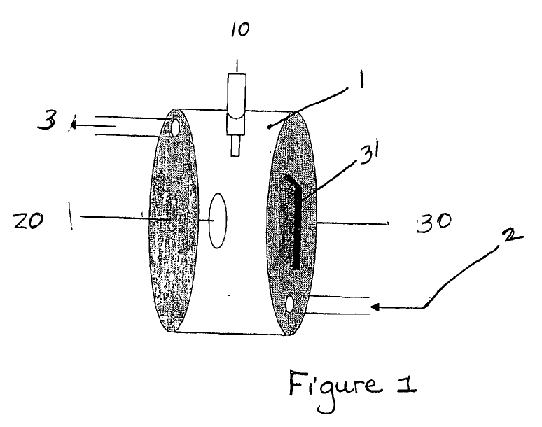

As shown in FIG. 1, the glucose quantification device for determining the concentration of glucose in a liquid medium comprises a reference electrode (10); a counter electrode (20) and a working electrode (30) with a semipermeable membrane (31) immersed in a liquid medium in which at least one chemical entity is dissolved. The liquid medium can be interstitial tissue fluid, peritoneal fluid, blood or electrolyte solutions. The glucose quantification device may further comprise a temperature control inlet (2) and a flow outlet (3) on the housing (1) of the glucose quantification device. In a preferred embodiment the chemical entity is glucose. The working electrode is preferably covered with an —NH₂ containing compound, such as Concanavalin A, glucokinase, GLUT2, or other proteins which bind glucose with affinity at the millimolar level. The reference electrode is comprised of metal, such as Ag/AgCl, Calomel, or metallic pseudo-reference electrode. The counter electrode is comprised of metal, such as platinum.

The working electrode is comprised of a semiconductor material. The working electrode may be a silicon chip wherein at least one surface covered with a thin layer of silicon oxide. In a preferred embodiment the semiconductor surface is silicon and is covered with immobilized Concanavalin A. The working electrode further comprises a semipermeable membrane which covers the semiconductor and allows for free diffusion of micromolecules through the semipermeable membrane but prevents macromolecules from contacting the Concanavalin A surface.

In one embodiment, the working electrode comprises an electrochemical surface comprising a silicon (Si) chip containing a surface covered with a thin layer of silicon oxide(SiO₂). The surface is derivatized with a silane preparation that contains active groups that cross-link to —NH2-derivatized DNA oligonucleotides. ConA is immobilized instead of the DNA oligo. Since conA contains —NH2 groups it need not be derivatized.

The semiconductor surface of the working electrode may be covered with immobilized conA and then immersed in liquid medium such as electrolyte solution that mimics the molecular composition of human extracellular fluid. As increasing concentrations of glucose are added to the solution, progressively larger amounts of glucose binds to conA, altering the electrochemical properties of the surface including the impedance. These changes are easily measured. Such measurements result in a reproducible shift in the impedance curve of the semiconductor, that can be translated into levels of glucose against a calibration standard.

Micromolecules include glucose and lectins. Macromolecules include enzymes, antibodies, and large proteins capable of degrading con A or interfering with its function.

A potentiostat is used to apply a measurement potential to the working electrode (30) relative to the reference electrode (10) corresponding to a measurement voltage during at least a portion of a measurement period, causing the chemical entity to participate in an electrochemical reaction at the working electrode (30). In one aspect the voltage applied to the potentiostat between the working electrode and the reference electrode can range from −2.0 to +2.0 and more particularly from −1.0 to +0.5V, while a 10 mV ac signal can superimposed at a frequency of about 100 kHz.

The electrochemical reaction results in a impedance measurement evoked current which corresponds to a measuring unit for the impedance measurement evoked current. A computer or other means for comparing the impedance measurement evoked current value with a predetermined control value is used to obtain a comparison result.

The glucose quantification device of the present invention may further comprise a feedback loop pump which administers an amount of insulin to a patient to modulate the glucose levels. One example of a feedback loop pump is portable pump for constant subcutaneous insulin infusion (CSII). The feedback pump may be programmed so that the infusion rate of insulin is constantly adjusted based on real-time data obtained from the glucose quantification device of the present invention. In this manner the glucose level in a subject would be maintained at a consistent level, and adjusted to respond to variables in the lifestyle of a subject. Such variables include activity level of the subject, dietary intake of the subject, metabolism factors, and changes in the emotional state of the subject.

A CSII pump can be coupled to the glucose quantification device so that blood glucose is quantified on a minute to minute basis. The result is a closed loop CSII or a “smart pump” that recapitulates the function of pancreatic beta cells and assures normal glucose levels with no risk of hypoglycemia and no effort on the part of the patient. Such a device consists of a pager-sized apparatus connected to the patient via a percutaneous (going through the skin) plastic catheter ans a percutaneous wire or sensor. A robust version of this system could even be implanted inside of the body as an “artificial pancreas” representing the closest advancement to a cure to diabetes that can be realistically hoped for in a time frame of years.

A method of modulating glucose in a patient comprises immersing the glucose quantification device in a liquid medium in which at least one chemical entity is present; applying a measurement potential to the working electrode relative to the reference electrode to result in an impedance measurement evoked current; measuring said impedance measurement evoked current; comparing the impedance measurement evoked current with a predetermined value to determine whether the chemical entity in the liquid medium is within a normal range; administering an amount of insulin to the patient to modulate the concentration of the chemical entity in the liquid medium and regulate glucose levels.

The whole glucose quantification device can measure from 0.5 to 1 cm in size. The main component is an integrated circuit that contains the active surface of the working electrode covered by a semipermeable membrane which allows rapid equilibration of glucose levels with interstitial fluid, permitting real-time measurements with insignificant lag time of 5 to 10 minutes or less depending on the placement of the sensor. The electronics for impedance measurements can be present on the working electrode, for instance the electronics can be miniaturized into the same chip. Results can be transmitted to a display or feedback loop pump. The device can be attached to a patient percutaneously with the wire going through the skin, or transcutaneously through intact skin with magnetic pickup, microwaves or other suitable technology. In one aspect the pump could be implanted so that no need for transmission of the measurements through the skin exists.

This method has been shown to detect non-covalent molecular interactions including precise Tₘ measurements for the detection of single-nucleotide mismatches. ConA immobilization was achieved by epoxyysilane grafting on the silicon layer of the chips, followed by addition of the lectin in an ionic buffer. The duration of the coating reaction of the silane functionalized chips with ConA was optimized to 90 minutes, using fluorescent imaging with FITC tagged ConA as the end-point. The optimized chips were then used for impedance measurements in a three-electrode design at 50 kHz in 0.15 mM NaCl, pH 7.4 in the presence of variable glucose concentrations. A pH close to the range of body fluids, or between 7.25 and 7.4 is preferred. A clear dose-dependant shift in the voltage/impedance curve was observed.

The present invention has the advantage of needing very simple equipment to perform electrochemical measurements using semiconductor/oxide chips, such as Si/SiO₂, as working electrodes, based on well characterized silicon technology; and allowing for miniaturization to then fabricate very high density arrays.

The present invention further uses sensor impedance measurement technology to measure a specific DNA sequence melting temperature (Tₘ). The hybridized oligonucleotide immobilized on the surface of the working electrode can be thermally dehybridized. This denaturation is recorded by measuring the impedance of the electrochemical system at different temperatures.

A measurement potential (dc voltage) is applied by the potentiostat between the working and the reference electrode, while an ac signal is superimposed, resulting in an impedance measurement evoked current. The signal treatment and the calculation of imaginary and real impedances are then performed by a computer program.

A typical Tₘ determination is performed by continuously measuring the impedance of the system while increasing the medium temperature with a set up. In one embodiment as shown in FIG. 1, the glucose quantification device is composed of a specially designed flow cell (1) connected to a temperature controlled inlet (2) system (±0.2° C.). A flow outlet (3) is also present to allow for continuous flow of the liquid medium. Both temperature and impedance values are then recorded simultaneously. The Tₘ values are chosen as the temperature at which changes in impedance non longer occur, assuming that the higher temperature value corresponds to the maximum matching of the 20-mer sequence and consequently to the most reliable Tₘ value.

The temperature measurements are relevant because the specific Tₘ of a DNA double strand, can be calculated theoretically by using Equation 1, and is highly dependent on the complementarity of the two strands involved. A single pair mismatch in a 20-mer double helix could induce a 5 to 10° C. decrease of the Tₘ depending on the G+C content of the sequence. A rapid determination of DNA Tₘs hybridized with immobilized known sequences provides a powerful tool to detect base mutations in gene sequences.

Equation 1 is as follows:

$${T}_{m} ( ° C . ) = \frac{[ 85.5 ( ° C . ) + 16.6 log M + 0.41 ( \% C + C ) ] - 500}{n - 0.61 ( \% formamide )}$$

where M=[Nₐ⁺]+[DNA]; and n=oligonucleotide base pair number.

The present invention uses as a model the determination of the c of a simple oligo-20-mer by impedance measurement.

Oligo-200-mer immobilization and hybridization optimization were studied. The chemical and physical modifications of the surface of the Si/SiO₂ chips are reflected by a flatband potential (V_{fb}) shifts, visualized by a translation of the imaginary impedance curves (Zᵢ) along the dc potential axis. Those shifts are related to changes in the amount of electrical charge accumulated at the SiO₂ electolyte interface. Consequently, the immobilization and hybridization of negatively charged DNA on the working electrode surface can be monitored by a chip's V_{fb} becoming more negative, i.e. a Zᵢ increase at a fixed dc potential.

This latter parameter is used to optimize the immobilization procedure with regard to the V_{fb} shift obtained after the hybridization step. A too high density of immobilized strands at the surface of the chip does not permit the complementary strands to hybridize due to steric hinderence. On the other hand a low strand density at the surface is not be sufficient to generate a significant V_{fb} shift upon hybridization.

Chips were prepared using different d(T)20 immobilization times (5, 15, 30, 60 and 120 minutes) while all other parameters for the immobilization and hybridization procedures were unchanged. The impedance curves for each chip were obtained before and after each step and the variation in the imaginary impedance at −300 mV was used to represent the curve shifts.

Long immobilization times of 60 and 120 minutes yielded large immobilization shifts while the corresponding hybridization shifts were small, demonstrating the presence of a high density of single strands at the surface to which few complementary strands can bind. Conversely, large hybridization shifts were observed following the low immobilization shifts for 5 to 15 minutes of the reaction time. A 15 minute immobilization time was sufficient to obtain a single strand layer with a good balance between density and steric hindrance.

Oligo d(T)₂₀ were immobilized on chips with a 15 minute incubation time and hybridized with d(A)₂₀, the evolution of the imaginary impedance curve before and after these two steps show a reproducible 50Ω shift is obtained after hybridization of the immobilized oligonucleotide.

A linear temperature ramp, from room temperature to 44° C. was then applied to two different d(T)20/d(A)₂₀ chips, while measuring the imaginary impedance variation at −300 mV. The impedance versus temperature curves (denaturation curves) were obtained. A reproducible 110 Ω Z, drop was clearly observed, which leveled off for temperatures higher than 32° C. This temperature was taken as the Tₘ for the d(T)/d(A) duplex since beyond that temperature no significant change in impedance was observed, Moreover, this experimental value compares very well to the theoretical one of 31.4° C. obtained by using Equation 1, above.

The denaturation curves obtained under the same conditions with a d(T)₂₀ grafted chip alone and in the presence of d(G)₂₀, with no d(A)₂₀ present, show that a single strand chip, i.e. d(T)₂₀ chip does not generate an impedance drop with increasing temperature. This finding indicates that the drop observed with the d(T)/d(A) chip is due to DNA released from the surface. Moreover, the d(T)₂₀ chip in the presence of d(G)d(G)₂₀, where the signal can be attributed to non-specific adsorption, gives a Zᵢ drop of only 35 Ω which indicates that approximately 70% of the drop obtained with the d(T)/d(A) chip corresponds to the real dehybridization of the double strand. The impedance based DNA chip is thus shown to enable the measurement of simple sequence Tₘs, and with a duration time as low as 15 minutes.

A label free DNA sensor was designed based on the measurement of charge variation using a semiconductor transduce. The sensor enables the detection of hybridization of immobilized DNA 20-mers through the measurement of flat band potential shifts toward the negative, i.e. an increase in impedance. The oligonucleotide immobilization method previously described has been improved upon and optimized in order to obtain the best hybridization impedance shift.

The DNA chips were then used to determine the melting temperature of an oligo-20-mer in a rapid, approximately 15 minutes, and direct manner. The device composed of a specially designed flow cell, enabled the measurement of impedance as a function of the circulating liquid medium's temperature. A drop in the impedance value is indicative of the temperature at which the hybridized oligonucleotides present at the surface are denatured. This temperature was shown to be specific to the 20-mer sequence.

This technology may be applied to the discrimination of wild and muted gene sequences, since the specific Tₘ of an oligonucleotide sequence is directly related to its base pair composition. The temperature range used encompasses a broad range of hybridization stringency conditions, differential Tₘ of alleles in a broad variety of sequence contexts can be examined in a single pass, making the method ideal for high-throughput, high-density genotyping arrays.

The present invention is further described by the following examples. These examples are provided solely to illustrate the invention by reference to specific embodiments. These examples, while illustrating certain aspects of the invention, do not portray the limitations or circumscribe the scope of the disclosed invention.

### EXAMPLES

### Example 1

### Reagents

Aminopropyltriethoxysilane (APTS) diisopropylethylmanine were purchased from Sigma-Aldrich. Aminolinker-d(T)₂₀ and d(A)₂₀ oligonucleotides were supplied by BioCorp Inc. The aminolinker is a C aliphatic chain terminated by a primary amino group and liked to the 5′ end of the oligonucleotide.

All other reagents are analytical reagent grade and all solutions are prepared in deionized distilled water (dd water).

### Example 2

### Silicon Working Electrode Silanization

The Si/So2 electrodes were 1 cm² n-type doped silicon chips covered with a 150 Å thick silicon dioxide layer. Prior to silanization, the chips were washed in boiling acetone and methanol for 5 minutes to remove any contaminants from the oxide surface. This surface was hydroxylated by dipping in sulfochromic acid (H₂SO₄+K₂Cr₂O₇) for four minutes, followed by washing in boiling water for ten minutes and drying at 140° C. for ten minutes. The chips were then immersed in a stirred 10% APTS, 1.2% di-iso-propylethylmanine solution in o-sylene under nitrogen atmosphere. After reaction for 45 minutes the chips were washed with dd water, dried under nitrogen and then stored at room temperature.

### Example 3

### Oligo-20-mer Immobilization and Hybridization

The APTS grafted chips are activated with glutaraldehyde by depositing a 40 μl drop of 25% glutaraldehyde on the surface for 15 minutes. After that time, the chip surface was extensively washed with dd water and covered with a 40 μl drop of the aminolinker-d(T)₂₀ (0.02 μg μl⁻¹ solution in saline phosphate buffer: PBS. The oligonucleotides were left to react for various times (5, 15, 30, 60 and 120 minutes) and the excess removed by extensive washing in dd water. The unreacted aldehyde groups were then saturated by dipping the chips for 20 minutes in a 0.1 M glycine solution.

Hybridization of complementary strands with the immobilized oligonucleotide probe layer was performed by dipping the DNA modified chip in a 2 ng μl⁻¹ solution of the complementary strand in PBS during 2 hours at 26° C. The non-specifically adsorbed strands were thereafter removed by extensive washing in dd water.

### Example 4

### Impedance Measurements

The Si/SiO₂ chips were used as working electrodes in a classical three electrodes in a classical three electrode potentiostatic set-up which includes a reference electrode (Ag/AgCl) and a platinum counter electrode. All impedance measurements are performed in PBS.

A dc voltage (from −1 to +0.5V) is applied by a potentiostat (Voltalab, Radiometer) between the working and the reference electrode, while a 10 mV rms ac signal is superimposed at a frequency of 100 kHz. The signal treatment and the calculation of imaginary and real impedances—i.e. Zᵢ and Zᵣ, respectively—are performed by a Voltamaster computer program.

A typical Tₘ determination is performed by continuously measuring the impedance of the system while increasing the medium temperature with a set up. In one embodiment as shown in FIG. 1, the glucose quantification device is composed of a specially designed flow cell (1) connected to a temperature controlled inlet (2) system (±0.2° C.). Both temperature and impedance values are then recorded simultaneously. The Tₘ values are chosen as the temperature at which changes in impedance non longer occur, assuming that the higher temperature value corresponds to the maximum matching of the 20-mer sequence and consequently to the most reliable Tₘ value.

What is claimed is:

1. A glucose quantification device for determining the concentration of glucose in a liquid medium comprising a reference electrode; a counter electrode and a working electrode with a semipermeable membrane immersed in a liquid medium in which at least one chemical entity is dissolved; a potentiostat for applying a measurement potential to the working electrode relative to the reference electrode corresponding to a measurement voltage during at least a portion of measurement period, and thereby causing said chemical entity to participate in an electrochemical reaction at the working electrode, said electrochemical reaction resulting in a impedance measurement evoked current, a measuring unit for said impedance measurement evoked current; and a means for comparing said impedance measurement evoked current with a predetermined value to obtain a comparison result.

2. The glucose quantification device of claim 1 wherein the liquid medium is blood.

3. The glucose quantification device of claim 1 wherein the chemical entity is glucose.

4. The glucose quantification device of claim 1 wherein the working electrode comprises a semiconductor wherein the semiconductor surface is covered with immobilized Concanavalin A which binds glucose.

5. The glucose quantification device of claim 4 wherein the semipermeable membrane allows for free diffusion of micromolecules but prevents macromolecules from contacting the Concanavalin A surface.

6. The glucose quantification device of claim 1 wherein the working electrode is a silicon chip containing at least one surface covered with a thin layer of silicon oxide.

7. The glucose quantification device of claim 1 wherein the reference electrode is Ag/AgCl.

8. The glucose quantification device of claim 1 wherein the counter electrode is platinum.

9. A glucose quantification device of claim 1 further comprising a feedback loop pump which administers an amount of insulin to a patient to modulate the glucose levels

10. A method of modulating glucose in a patient comprising:
a) immersing a glucose quantification device comprising a reference electrode; a counter electrode and a working electrode with a semipermeable membrane in a liquid medium in which at least one chemical entity is present;
b) applying a measurement potential to the working electrode relative to the reference electrode to result in a impedance measurement evoked current;
c) measuring said impedance measurement evoked current;
d) comparing said impedance measurement evoked current with a predetermined value to determine whether the chemical entity in the liquid medium is within a normal range;
e) administering an amount of insulin to the patient to modulate the concentration of the chemical entity in the liquid medium and regulate glucose levels.

11. The method of claim 10 further comprising the step of determining the Tₘ by continuously determining the impedance measurement evoked current value over a period of time while increasing the temperature of the liquid medium.
